(19) United States
(12) Patent Application Publication
(10) Pub. No.: US 2011/0098865 A1
(43) Pub. Date: Apr. 28, 2011

(54) POWER DISTRIBUTING SYSTEM

(75) Inventors: Hiroaki Kitano, Tokyo (JP); Shigeru Tajima, Kanagawa (JP)

(73) Assignee: Sony Corporation, Tokyo (JP)

(21) Appl. No.: 12/887,913

(22) Filed: Sep. 22, 2010

(30) Foreign Application Priority Data
Oct. 23, 2009 (JP) 2009-244425

(51) Int. Cl. G06F 1/26

(52) U.S. Cl. 700/286; 713/300

(57) ABSTRACT

There is provided a power distributing system including a power supply server that outputs power to a bus line at a predetermined timing, a client that receives the power output by the power supply server via the bus line, and a switching distribution system unit that switches a distribution system with respect to the bus line. The switching distribution system unit switches power transmitting/receiving system between the power supply server and the client into power transmitting/receiving system of commercial power, and disconnects the power transmitting/receiving system of commercial power so that the power transmitting/receiving system between the power supply server and the client becomes effective

### BACKGROUND OF THE INVENTION

1. Field of the Invention

The present invention relates to a power distributing system.

2. Description of the Related Art

Many electronic devices, such as personal computers and game machines, use altering-circuit (AC) adapters for their operating and for charging their batteries. AC power is input to an AC adapter from a commercial power source, and then power adapted to a device is output from the AC adapter. Ordinary electric devices operate by a direct-current (DC), where the voltage and/or the current of each device may be different from each other. Accordingly, the standards of AC adapters for outputting power adapted to each device would be different for each device, which results in the disadvantageously increased number of AC adapters for the increased number of devices. Even similarly-shaped AC adapters may not be compatible with each other.

For such disadvantage, there is proposed a power source bus system, in which a power supply block for supplying power to a device, such as a battery or an AC adapter, and a power consuming block for being supplied with the power from the power supply block are connected to one common direct-current bus line (See JP 2001-306191 (A) and JP 2008-123051 (A)). In such power source bus system, a direct current flows through the bus line. Each block is described as an object, and the object for each block transmit/receive information (state data) to/from each other through the bus line. Furthermore, the object for each block generates the information (state data), based upon a request from an object for another block, and transmits it as a response data. Then, the object for the block received the response data can control power supply and consumption, based upon the contents of the received response data.

### SUMMARY OF THE INVENTION

In the power source bus system shown in the JP 2008-123051 (A), a plurality of power modes exist in a time division manner on a power line. The power mode used in such power source bus system is different from an existing grid power. Therefore, there has been a problem that it is difficult to be used in conjunction with an existing house wiring for supplying commercial power without any further processes.

In light of the foregoing, it is desirable to provide a novel and improved power distributing system, which supplies power in a time division manner and is capable of being used in conjunction with an existing commercial power system to use.

According to an embodiment of the present invention, there is provided a power distributing system which includes a power supply server that outputs power to a bus line at a predetermined timing, a client that receives the power output by the power supply server via the bus line, and a switching distribution system unit that switches a distribution system with respect to the bus line. The power supply server may supply power agreed with the client in a predetermined power supply section that is regularly repeated to the client establishing agreements on power supply with, as well as transmits and receives information signal indicating information with the client to which power is supplied. The client may receive power agreed with the client in a predetermined power supply section that is regularly repeated from the power supply server establishing agreements on power supply with, as well as transmits and receives information signal indicating information with the power supply server from which power is supplied. The switching distribution system unit may switch power transmitting/receiving system between the power supply server and the client into power transmitting/receiving system of commercial power, and may disconnect the power transmitting/receiving system of commercial power so that the power transmitting/receiving system between the power supply server and the client becomes effective

The switching distribution system unit may includes a terminal that connects to power transmitting/receiving system of the commercial power, a terminal that connects to power transmitting/receiving system from the power supply server, and a terminal that disconnects power transmitting/receiving system of the commercial power and power transmitting/receiving system from the power supply server.

The power distributing system may further include more than one secondary power switchgear that is provided respectively corresponding to more than one secondary distribution system. The power supply server and the client may be connected in downstream side of specific secondary power switchgear.

The specific secondary power switchgear may include a terminal that connects to power transmitting/receiving system of the commercial power, a terminal that connects to power transmitting/receiving system from the power supply server, and a terminal that disconnects power transmitting/receiving system of the commercial power and power transmitting/receiving system from the power supply server.

A device that is not supplied power from the power supply server may connect to a bus line using a connector that has a switch to be powered-on to receive AC power when the AC power at a predetermined frequency flows on a bus line to which power is supplied from AC commercial power and the power supply server.

As described above, according to the present invention, it is possible to provide a novel and improved power distributing system, which supplies power in a time division manner and is capable of being used in conjunction with an existing commercial power system to use.

### BRIEF DESCRIPTION OF THE DRAWINGS

FIG. 1 is an explanatory view showing a configuration of a power supply system according to an embodiment of the present invention;

FIG. 2 is an explanatory view for explaining a power supply processing by a power supply system 1 according to an embodiment of the present invention;

FIG. 3 is an explanatory view showing a configuration of a power distribution system for using a power supply system according to the embodiment of the present invention in conjunction with an existing commercial power system;

FIG. 4 is an explanatory view showing an example of a state when the power distributing system shown in FIG. 3 is connected with a power supply server, a client, or the like;

FIG. 5 is an explanatory view showing a configuration of a power-packet compatible connector 700 for connecting existing devices to a power-packet compatible bus line;

FIG. 6 is an explanatory view showing a configuration example of the power-packet compatible connector 700; and

FIG. 7 is an explanatory view showing a configuration of a power distribution system 800 for using a power supply system according to the embodiment of the present invention in conjunction with an existing commercial power system.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Descriptions will be made in the following order:

<1. An Embodiment of the Present Invention>
[1-1. Configuration of Power Supply System]
[1-2. Power Supply Processing by Power Supply System]
[1-3. Coexistence with an Existing Commercial Power Service]

<2. Conclusion>

<1. An Embodiment of the Present Invention>
[1-1. Configuration of Power Supply System]

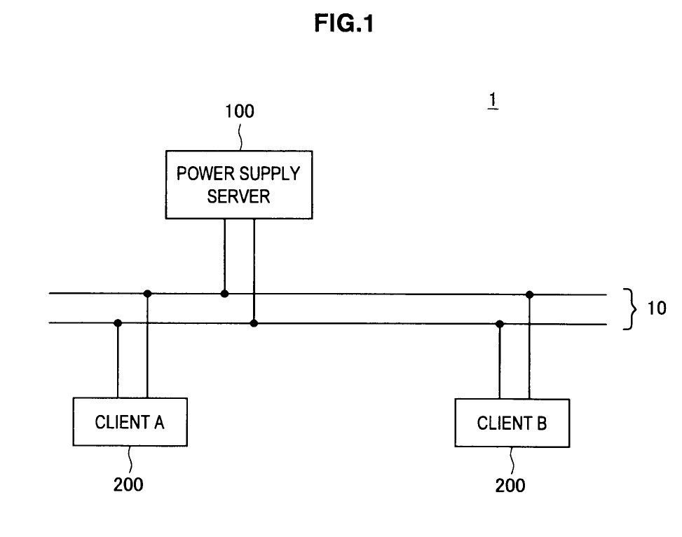

First, a configuration of a power supply system according to an embodiment of the present invention will be described. FIG. 1 is an explanatory view showing the configuration of the power supply system according to the embodiment of the present invention. Hereinafter, the configuration of the power supply system according to the embodiment of the present invention will be described using FIG. 1.

As shown in FIG. 1, the power supply system 1 according to the embodiment of the present invention includes a power supply server 100 and clients 200. The power supply server 100 and the clients 200 are connected to each other via a bus line 10.

The power supply server 100 supplies DC power to the clients 200. Moreover, the power supply server 100 transmits/receives information signals to/from the clients 200. In this embodiment, the bus line 10 is utilized for both supplying DC power and transmitting/receiving information signals between the power supply server 100 and the clients 200.

The power supply server 100 includes a communication-use modem for transmitting/receiving information signals, a microprocessor for controlling power supply, a switch for controlling the output of the DC power, etc.

The client 200 receives the DC power supply from the power supply server 100. The client 200 further transmits and receives the information signal to and from the power supply server 100. In FIG. 1, the two clients 200 are illustrated. In the following description, for convenience's sake of explanation, the two clients 200 are distinguished respectively as CL1 or CL2.

The client 200 is configured to include a communication modem for use in transmitting and receiving the information signal and a microprocessor for use in controlling the electric power supply, and a switch controlling the DC power output.

In the power supply system 1 shown in FIG. 1, the single power supply server 100 and the two clients 200 are illustrated. However, in the present invention, the number of the power supply servers and the number of the clients are not obviously limited to the example.

Since a method of supplying electric power in the power supply systems 1 and 2 shown in FIG. 1 is described in Japanese Patent Application Laid-Open No. 2008-123051, the detailed description will be omitted. However, hereinafter, a power supply processing by the power supply system 1 according to an embodiment of the present invention will be briefly described.
[1-2. Power Supply Processing by Power Supply System]

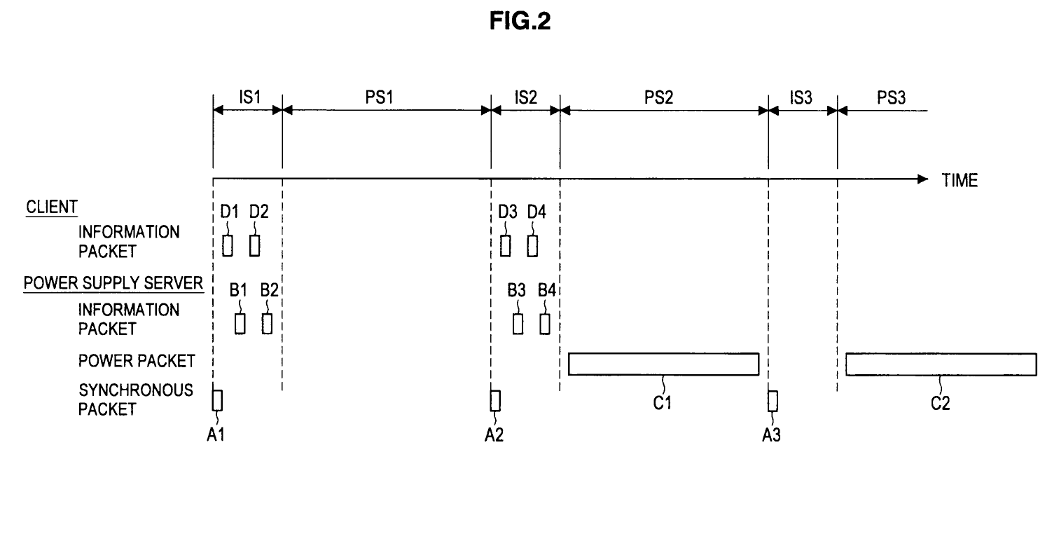

FIG. 2 is an explanatory view for explaining the power supply processing by the power supply system 1 according to an embodiment of the present invention. Hereinafter, the power supply processing by the power supply system 1 according to each of the above embodiments of the present invention will be described using FIG. 2.

As shown in FIG. 2, the power supply server 100 periodically outputs synchronous packets A1, A2, A3, and . . . to the bus line 10. The power supply server 100 further outputs information packets B1, B2, B3, and . . . and power packets C1, C2, C3, and . . . so as to supply electric power to the client 200. The information packets B1, B2, B3, and . . . are the information signals transmitted and received to and from the client 200, and the power packets C1, C2, C3, and . . . are obtained by packetizing an electric power energy. Meanwhile, the client 200 outputs information packets D1, D2, D3, and . . . that are the information signals transmitted and received to and from the power supply server 100 so as to receive electric power supply from the power supply server 100.

The power supply server 100 outputs the synchronous packets A1, A2, A3, and . . . at the start of a time slot of a predetermined interval (for example, every 1 second). The time slot includes an information slot through which the information packet is transmitted and a power slot through which the power packet is transmitted. Information slots IS1, IS2, IS3, and . . . are sections where the information packets are exchanged between the power supply server 100 and the client 200. Power supply slots PS1, PS2, PS3, and . . . are sections where the power packets C1, C2, C3, and . . . supplied from the power supply server 100 to the client 200 are output. The information packet is a packet capable of performing output only in the sections of the information slots IS1, IS2, IS3, and . . . Thus, when the transmission and reception of the information packet is not completed in one information slot, the information packet is transmitted over a plurality of information slots. Meanwhile, the power packet is a packet capable of performing output only in the sections of the power supply slots PS1, PS2, PS3, and . . .

The power supply server 100 has one or two or more server power supply profiles showing a power specification that can be supplied by itself. The client 200 receives the electric power supply from the power supply server 100 which can supply electric power matching to its own specification. At this time, the client 200 obtains a server power supply profile from the power supply server 100 and determines the specification (server power supply profile) of the power supply server 100 for the client 200 itself. Specifically, the client 200 first detects a synchronous packet Al to be output to the power supply server 100 and obtains the address of the power supply server 100 included in the synchronous packet A1. The address may be a MAC address, for example. Next, the client 200 transmits to the power supply server 100 an information packet D1 that requests transmission of the number of the server power supply profiles possessed by the power supply server 100.

The power supply server 100 having received the information packet D1 transmits a server power supply profile number in the information packet B1. The server power supply profile number is the number of the server power supply profiles of the power supply server 100. The client 200 having received the information packet B1 obtains from the power supply server 100 the contents of the server power supply profile with the number equal to the number of the server power supply profiles of the power supply server 100. For example when the power supply server 100 has two server power supply profiles, the client 200 first obtains one of the two server power supply profiles. The client 200 having received one of the two server power supply profiles transmits to the power supply server 100 the server power supply profile as the information packet D2 requesting the use of the power supply.

The power supply server 100 having received the information packet D2 transmits a first server power supply profile as the information packet B2 to the client 200. The first server power supply profile is stored in a storage part (not shown) included in the power supply server 100. The client 200 having received the information packet B2 from the power supply server 100 transmits the information packet for use in obtaining a second server power supply profile. However, the information slot IS1 terminates at this point, and the power supply slot PS1 for use in transmitting the power supply packet starts. Thus, this information packet is transmitted in the next information slot IS2. In the power supply slot PS1, since the power specification that the client 200 receives electric power from the power supply server 100 is not determined, and the electric power supply is not performed.

The power slot PS1 terminates, and the synchronous packet A2 showing the start of the next time slot is output from the power supply server 100. Thereafter, the client 200 having received the information packet B2 from the power supply server 100 transmits the information for use in obtaining the second server power supply profile as the information packet D3.

The power supply server 100 having received the information packet D3 transmits the second server power supply profile as the information packet B3 to the client 200. The second server power supply profile is stored in a storage part (not shown) included in the power supply server 100. The client 200 having received the information packet B3 to obtain the two server power supply profiles of the power supply server 100 selects the server power supply profile with a power specification matching to the client 200 itself. The client 200 then transmits to the power supply server 100 the information packet D4 for use in determining the selected server power supply profile.

The power supply server 100 having received the information packet D4 transmits information, which serves as the information packet B4 and represents such a response that the power specification is determined, to the client 200 so as to notify the completion of the determination of the first server power supply profile to the client 200. Thereafter, when the information slot IS2 terminates and the power slot PS2 starts, the power supply server 100 outputs the power supply packet C1 to the client 200 and performs power supply. With regard to the timing of transmission of the power packet, a power supply start time can be designated by the client 200 to the power supply server 100 by using the information representing a transmission start time setting request.

Hereinbefore, the power supply processing by the power supply system 1 according to each of the above embodiments of the present invention has been described.
[1-3. Coexistence with an Existing Commercial Power Service]

A power distribution board or switchboard in ordinary houses or offices has a main switchgear (breaker) at an indoor lead-in. Generally, an electricity contract for the house is decided based on current capacity of this main switchgear. The role of the main switchgear is a safety gear to disconnect overload currents, while remaining role is to determine the price of the electricity contract. Then this existing main switchboard has only 2 positions, “connect” and “disconnect”.

Meanwhile more devices used at home operate on DC power. An induction motor of a fan, or devices using alternative current, for example, are now the only devices operating only on AC power of 100V at 50 Hz or 60 Hz, and the number of those devices are getting fewer. Moreover, devices operating on DC power (such as personal computers) has a built-in battery and do not necessarily need to be supplied with AC power all the time. Such devices are expected to be increased spontaneously in future, and it is also expected that the future market will have more devices with a built-in battery which is compatible with the power source bus system provided in the JP 2008-123051 (A) or the like by the same inventor with the present invention.

Considering the era where more devices will be compatible with the power source bus system provided in the JP 2008-123051 (A) or the like mentioned above, the distribution equipment for home-use that is the end terminal of existing grid may be disconnected from the grid for certain period of time, and may be connected to other power system different from the commercial power. Some power system with home-use distribution can be operated on another power system except the commercial power. Especially, electric automobiles are getting more popular, the power supply capacity of the existing grit will not keep up with the requirements, then local (at home, etc) electric generation will be desired. In such an environment, it will be desired a method to select between the power from the grid and the power generated locally, depending on time and power system.

Subsequently, the embodiment of the present invention will be explained hereinafter, a configuration to switch selectively between an existing power system and a power system provided by the power source bus system which is disclosed in the JP 2008-123051 (A).

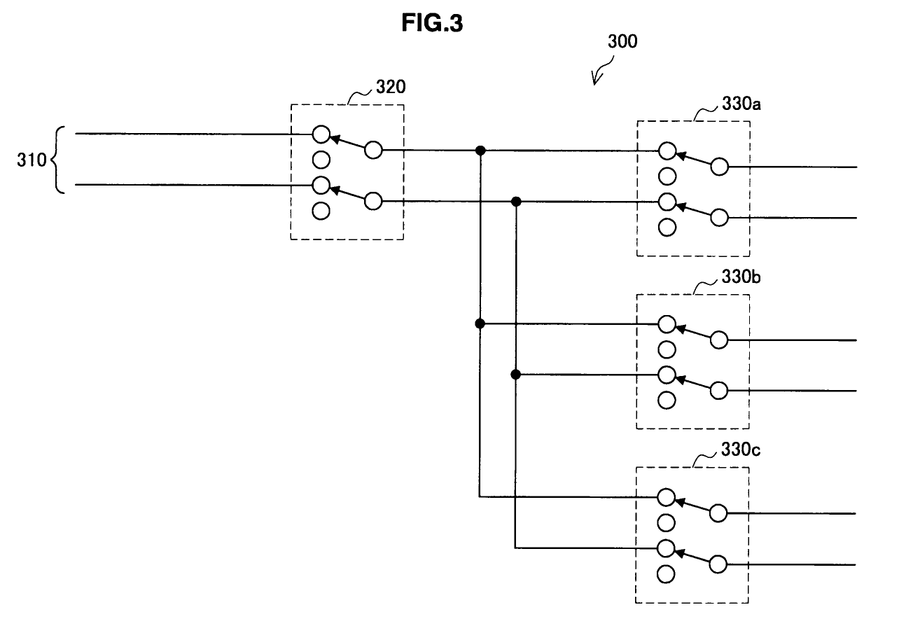

FIG. 3 is an explanatory view showing a configuration of a power distribution system for using a power supply system according to the embodiment of the present invention in conjunction with an existing commercial power system. Hereinafter, the configuration of a power distribution system for using a power supply system according to the embodiment of the present invention in conjunction with an existing commercial power system will be explained with reference to FIG. 3.

As shown in FIG. 3, a power distributing system 300 includes a power line 310, a main switchgear 320, and secondary switchgears 330a, 330b and 330c. Today, the existing AC power is generally distributed to each home in three-phase, and 100V is distributed using the 2^{nd} phase thereof. The example shown in FIG. 3 illustrates all the cases in two-phase in order to simplify the explanation.

The main switchgear 320 is capable of disconnecting all the power systems at once. The secondary switchgears 330a, 330b and 330c are to connect or disconnect each distribution system, and when any of the secondary switchgears 330a, 330b or 330c is open, the power is not supplied only for the power systems compatible for the open secondary switchgears 330a, 330b or 330c.

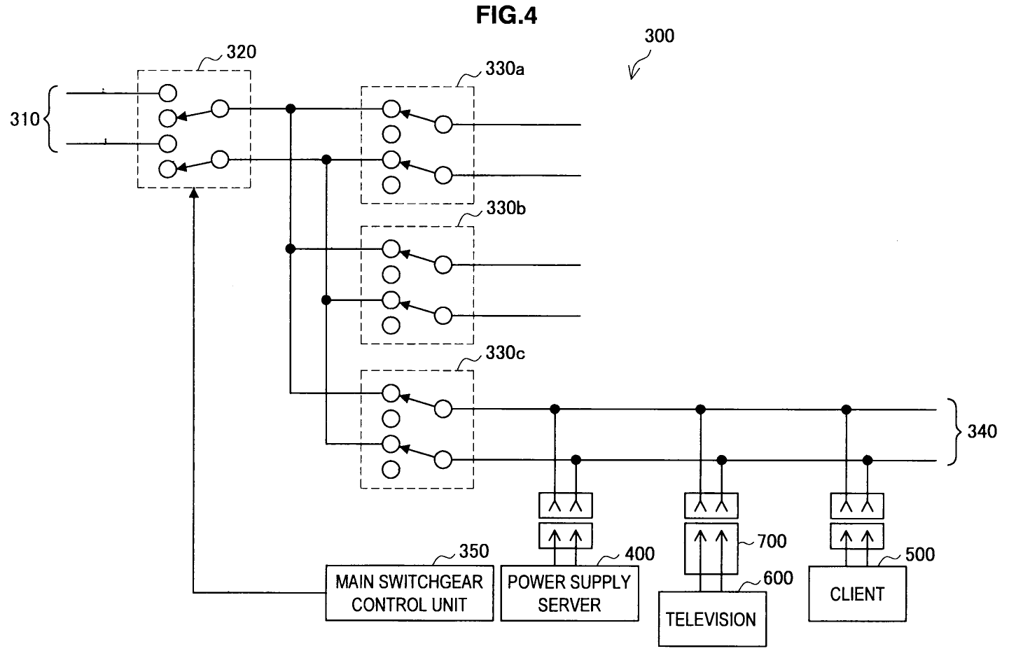

Now, an explanation will be given on the operation of the power distributing system shown FIG. 3. FIG. 4 is an explanatory view showing an example of a state when the power distributing system 300 shown in FIG. 3 is connected with a power supply server, a client, or the like. The example in FIG. 4 illustrates a case where the power supply server 400 and the client 500 which are operated by the power source bus system provided in the JP 2008-123051 (A) as described above (hereinafter referred to as power-packet compatible) is connected to the AC line 340 connected to the secondary switchgear 330c. Moreover, FIG. 4 also illustrates a main switchgear control unit 350 for operating the main switchgear 320 remotely. The main switchgear control unit 350 is for controlling the switching status of the main switchgear 320 by wired or wireless connection, and enables a remote controlling the switching status of the main switchgear 320 without difficulties.

When the main switchgear 320 is disconnected in the configuration shown in FIG. 4, the distribution system is completely separated from the existing power system, and the AC line 340 simply becomes a two-wire power bus. If a power supply server 400 compatible with power-packet or a client 500 consuming the power supplied from the power supply server 400 are connected to the AC line 340 in this status, the above-described power supply system provided in the JP 2008-123051 (A) or the like will be realized. This power source bus system may be power-packet compatible while using the existing AC line 340. Note that the AC line 340 may have another GND line in wiring in some cases, however, such GND line is not used for the present power source bus system.

More specifically, the existing two-wire AC line 340 becomes a power-packet compatible bus line, and a power packet is transmitted to the client 500 from the power supply server 400. For the AC line 340, a power source (the power supply server 400) and a load (the client 500) is to be able to dynamically connect and disconnect.

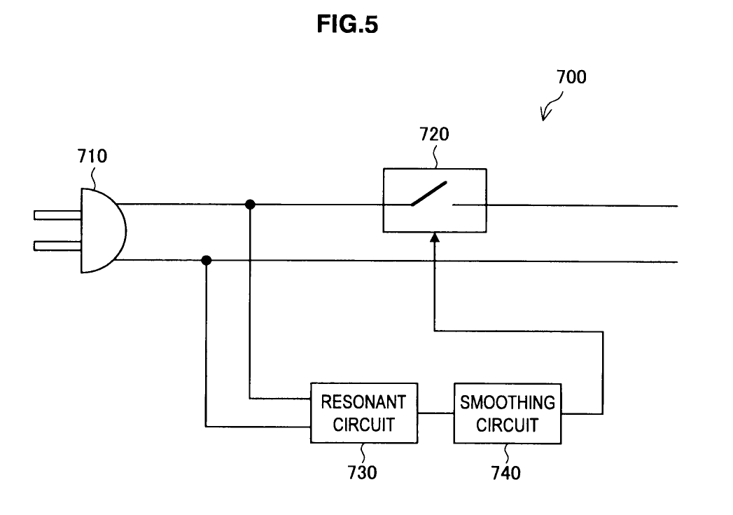

However, in a case such power supply system as shown in FIG. 4 uses a connector same with the one used in the existing wiring for home, if an existing device (a television 600, for example) is connected, the television 600 cannot be supplied power from the power supply server 400 since it is not power-packet compatible. Therefore, an existing-grid and power-packet dual system uses the power-packet compatible connector shown in FIG. 5 as a connector.

FIG. 5 is an explanatory view showing a configuration of a power-packet compatible connector 700 for connecting existing devices to a power-packet compatible bus line. The power-packet compatible connector 700 has a configuration compatible with both power supply and power receiving. This configuration may use the one disclosed in an invention of the Japanese Patent Application No. 2008-322547 titled as “Plug, plug socket and power supply system” by the same inventor of the present invention.

As shown in FIG. 5, the power-packet compatible connector 700 includes a plug 710, an AC switch 720 that is configured of semiconductor, a resonant circuit 730, and a rectifying and smoothing circuit 740.

The AC switch 720 does not get involved in a protocol of the power-packet or the like, and is turned-on only when the plug 710 is connected and the input from the bus line is at AC 50 Hz or 60 Hz. The power of AC 100V at 50 Hz or 60 Hz is to be supplied to the house wiring depending on time slot or selection by a user of the power distributing system 300. The power-packet compatible connector 700 shown in FIG. 5 is applied to the existing devices operated on this AC power as a power source. The power-packet compatible connector 700 shown in FIG. 5 itself is not necessarily compatible with the power-packet system, and since it is configured of a simple passive filter and an AC semiconductor switch, it can be produced at low price.

On the other hand, when using a power-packet compatible device, a switch is arranged inside a connector or the power-packet compatible device, and negotiation is executed with a server in the same bus line in advance. Then the switch cannot be turned-on unless and the negotiation with the server is completed. Therefore, there is no problem even though the power-packet compatible device is connected to an AC wiring in the existing grid.

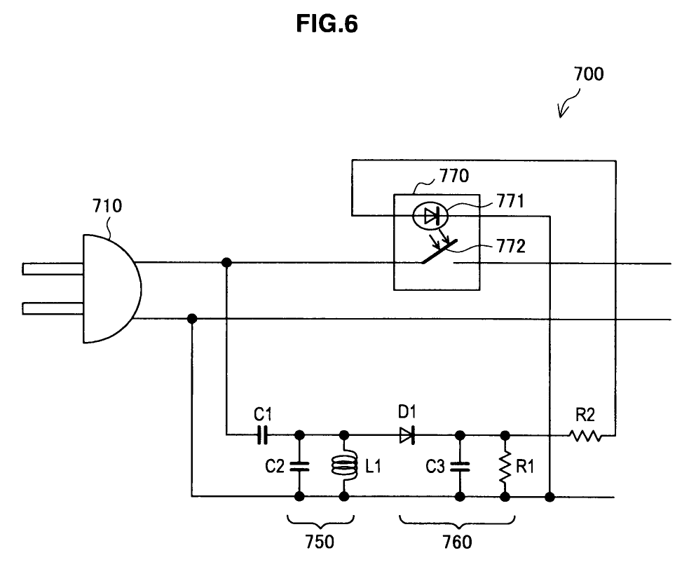

Next, a configuration example of the power-packet compatible connector 700 will be explained. FIG. 6 is an explanatory view showing a configuration example of the power-packet compatible connector 700. In the configuration example shown in FIG. 6, the power-packet compatible connector 700 includes a condenser C1, a tunable filter 750, a smoothing circuit 760, and a switch circuit 770.

The condenser C1 is a coupling condenser for AC conducting. The tunable filter 750 which includes a condenser C2 and a coil L1, is a filter that is configured to have a resonance point at 50 Hz or 60 Hz of the condenser C2 and the coil L1. The tunable filter 750 extracts AC power at 50 Hz or 60 Hz to be converted into DC power in the smoothing circuit 760 in the down-stream.

The smoothing circuit 760 which is configured from a diode D1, a condenser C3, and a resistor R1, converts the AC power at 50 Hz or 60 Hz extracted by the tunable filter 750 described above. This DC power lights up a LED 771 in the switch circuit 770, and turns-on the switch 772. Note that it is generally often used a switch whose the primary side and the secondary side are optically insulated as AC semiconductor switch.

Since it is basically determined by filtering at 50 Hz or 60 Hz whether there is a commercial power supply, when transmitting the AC power in packets in the power packet system, transmission at 50 Hz or 60 Hz is restricted. When using a kind of power which does not meet this requirement (for example, a direct output of a wind-powered AC generator), the power is converted from AC to DC before supplying the power to the bus line.

In the above explanation, a connector of the existing device is exchanged with the power-packet compatible connector, however, it is possible to change the existing connector itself to the power-packet compatible connector. To change the existing connector to the power-packet compatible connector, its configuration should be to have a built-in switch which turns on when detecting the power of nearly 100V at DC 50 Hz or 60 Hz on the side of a plug (an outlet), and to supply the power only if there is an existing power of 100V at DC 50 Hz or 60 Hz in the wiring. It is recommended to connect such power-packet non-compatible connector with a power-packet compatible connector in parallel.

In the configuration example of the power distributing system 300 shown in FIG. 4 described above, connection and disconnection with the existing power distributing system can be controlled by disconnecting the main switchgear 320. It is inconvenient, however, if the connection and disconnection of the main switchgear 320 is operated manually like the existing switchgear (a breaker). Therefore, it is desirable to use a switchgear which can be remotely controlled for the main switchgear 320. Such switchgear which can be remotely controlled has been already realized by what is called a smart meter. So this smart meter can be also used for the main switchgear 320. Other than the smart meter, any switchgear which can be remotely controlled can be manufactured using the existing technologies.

In the power distributing system 300 shown in FIG. 4, after the main switchgear 320 is disconnected, the power-packet system is to supply all the power system which has been supplied by the main switchgear 320. Due to this, a part of devices connected to this power-packet system may have some difficulties in use. A method for resolving this problem will be explained as below.

An ordinary existing home wiring has secondary switchgears in the down-stream side of main switchgear to divide into some wiring systems. There is a method in which these systems are divided into two groups, one includes only systems which constantly need power or those which deal with relatively large amount of power, and another group includes the remaining. Then the latter is to be used as power-packet compatible in this method. There is an actual case where a system for an air-conditioner belongs to a different wiring system from other systems in wiring for home.

Therefore, if a system connected to a certain secondary switchgear (for example, the secondary switchgear 330a in FIG. 4) is modified to a power-packet compatible and to be controlled remotely, once the systems connected to the secondary switchgear are disconnected from the existing bus line, the system connected to the secondary switchgear can be used as a power transmission and distributing system which is power-packet compatible. In this case, same as the explanation in the above embodiment, it is preferable that a connector should be a power-packet compatible connector, and can be compatible with both of the cases to be supplied with: AC power at 50 Hz or 60 Hz, or power-packet.

In the above explanation, there are only two junctions of on or off for both of the main switchgear and the secondary switchgear. In the following, an explanation will be given on a configuration in which a third junction is arranged in the main switchgear and a power-packet compatible bus line is to be connected to a system for the third junction.

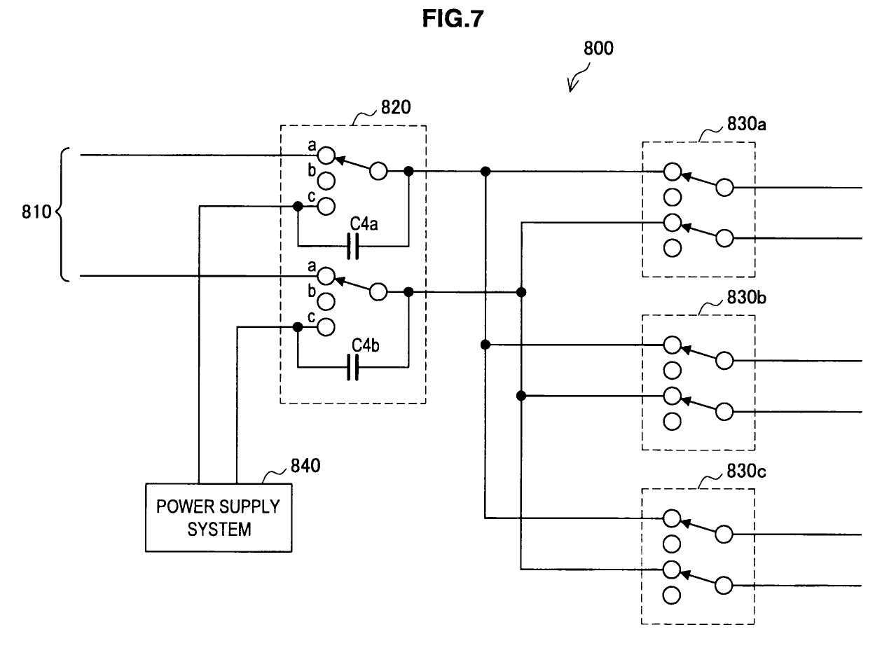

FIG. 7 is an explanatory view showing a configuration of a power distribution system 800 for using a power supply system in conjunction with an existing commercial power system according to the embodiment of the present invention. Hereinafter, the configuration of the power distributing system will be explained with reference to FIG. 7.

As shown in FIG. 7, the power distributing system includes a power line 810, a main switchgear 820 a secondary switchgears 830a, 830b and 830c, and the power supply system 840.

The main switchgear 820 is a switchgear having three terminals. When the main switchgear 820 is connected to a position a, the power distributing system 800 is connected to the existing distributing system, and when connected to a position b, the power distributing system 800 is disconnected from the existing distributing system. Further, when the main switchgear 820 is connected to a position c, the power distributing system 800 is in a state to be operated on the power supplied from the power supply system 840 which is power-packet compatible. Note that the main switchgear 820 includes condensers C4a and C4b. The condensers C4a and C4b are condensers for high-frequency connection, and connect the power supply system 840 and a side of the secondary switchgears 830a, 830b and 830c in a high-frequency connection. Note that in order to avoid the existing power line 810 and the power supply system 840 from connecting with each other, a choke coil may be arranged between the power line 810 and main switchgear 820. Moreover, as for the side of existing line of these secondary switchgears 830a, 830b, 830c, it is desirable that a connector is power-packet compatible described above.

In the power distributing system 800 having a configuration shown in FIG. 7, when the main switchgear 820 is connected with the position c that is the third junction, the entire system to which the third junction is connected is to be a new power-packet system. At this time, the third junction is shorted out by the condensers C4a and C4b at high-frequency, and even if the existing AC power 50 Hz or 60 Hz is supplied, and power-packet system device does not receive (cannot receive) the power, it is preferable to prepare to synchronize as the power-packet system.

In the power distributing system 800 shown in FIG. 7, when a terminal of the main switchgear 820 is connected to the position a, and the power distributing system 800 is connected to the existing grid, the secondary switchgears 830a, 830b and 830c are supplied with the power at AC 50 Hz or 60 Hz, and the power supply system 840 operates independently from the existing grid.

On the other hand, when a terminal of the main switchgear 820 is connected to the position c, and the power distributing system 800 is connected to the power supply system 840 that configures a power-packet system, since the power of AC 50 Hz or 60 Hz is to be disappeared from the power distributing system 800, connectors for the existing devices having the above-mentioned configuration is to be off automatically by its built-in switch. Meanwhile, clients and servers compatible with power-packet devices start communication with a synchronous server (not shown) that exists within the power distributing system 800, register the existence to the synchronous server, and start operations as a server or a client. Note that the main switchgear 820 used in the configuration shown in FIG. 7 may be controlled not manually, but remotely from the control line.

In the above explanation, the main switchgear 820 is arranged with three terminals, however, the present invention is not limited to this. For example, it may be a case where the secondary switchgears 830a, 830b and 830c are arranged with three terminals and may be used switching between a terminal for receiving the power supply from the existing commercial power, a terminal for receiving the power supply from the power packet system, and a terminal that is not for receiving from any of these.

<2. Conclusion>

As explained above, according to the embodiments of the present invention, it is possible to use a power supply system which supplies the power in a time division manner in conjunction with the existing commercial power system, by arranging a method to control switching of a main switchgear and secondary switchgears.

It should be understood by those skilled in the art that various modifications, combinations, sub-combinations and alterations may occur depending on design requirements and other factors insofar as they are within the scope of the appended claims or the equivalents thereof.

The present invention can be applicable to a power supply system, particularly to the power supply system that transmits power and information in a time division manner.

The present application contains subject matter related to that disclosed in Japanese Priority Patent Application JP 2009-244425 filed in the Japan Patent Office on Oct. 23, 2009, the entire content of which is hereby incorporated by reference.

What is claimed is:

1. A power distributing system comprising:
a power supply server that outputs power to a bus line at a predetermined timing;
a client that receives the power output by the power supply server via the bus line; and
a switching distribution system unit that switches a distribution system with respect to the bus line,
wherein the power supply server supplies power agreed with the client in a predetermined power supply section that is regularly repeated to the client establishing agreements on power supply with, as well as transmits and receives information signal indicating information with the client to which power is supplied,
wherein the client receives power agreed with the client in a predetermined power supply section that is regularly repeated from the power supply server establishing agreements on power supply with, as well as transmits and receives information signal indicating information with the power supply server from which power is supplied, and
wherein the switching distribution system unit switches power transmitting/receiving system between the power supply server and the client into power transmitting/receiving system of commercial power, and disconnects the power transmitting/receiving system of commercial power so that the power transmitting/receiving system between the power supply server and the client becomes effective.

2. The power distributing system according to claim 1,
wherein the switching distribution system unit including a terminal that connects to power transmitting/receiving system of the commercial power, a terminal that connects to power transmitting/receiving system from the power supply server, and a terminal that disconnects power transmitting/receiving system of the commercial power and power transmitting/receiving system from the power supply server.

3. The power distributing system according to claim 1,
further comprising more than one secondary power switchgear that is provided respectively corresponding to more than one secondary distribution system,
wherein the power supply server and the client are connected in downstream side of specific secondary power switchgear.

4. The power distributing system according to claim 3,
wherein the specific secondary power switchgear including a terminal that connects to power transmitting/receiving system of the commercial power, a terminal that connects to power transmitting/receiving system from the power supply server, and a terminal that disconnects power transmitting/receiving system of the commercial power and power transmitting/receiving system from the power supply server.

5. The power distributing system according to claim 1,
wherein a device that is not supplied power from the power supply server connects to a bus line using a connector that has a switch to be powered-on to receive AC power when the AC power at a predetermined frequency flows on a bus line to which power is supplied from AC commercial power and the power supply server.
